(19) United States
(12) Patent Application Publication
(10) Pub. No.: US 2021/0319420 A1
(43) Pub. Date: Oct. 14, 2021

(54) RETAIL SYSTEM AND METHODS WITH VISUAL OBJECT TRACKING

(71) Applicant: Shenzhen Malong Technologies Co., Ltd., Shenzhen (CN)

(72) Inventors: Yuechen YU, Shenzhen (CN); Yilei XIONG, Shenzhen (CN); Weilin HUANG, Shenzhen (CN); Matthew Robert SCOTT, Shenzhen (CN)

(21) Appl. No.: 16/846,385

(22) Filed: Apr. 12, 2020

(51) Int. Cl. G06Q 20/18; G06N 20/00; G06T 7/246; G08B 13/196

(52) U.S. Cl. CPC G06Q 20/18; G06N 20/00; G06T 2207/20081; G08B 13/19608; G06T 2207/30232; G06T 7/246

(57) ABSTRACT

This disclosure includes technologies for object tracking in general. The disclosed system can detect the event type based on one or more tracked objects. Further, appropriate responses may be invoked based on the event type.

### CROSS-REFERENCE TO RELATED APPLICATIONS

The present application is related to and incorporates by reference herein in its entirety, pending U.S. application Ser. No. 16/672,883, filed Nov. 4, 2019; pending International Application No. PCT/CN2019/111643, filed Oct. 17, 2019; pending International Application No. PCT/CN2019/086367, filed May 10, 2019.

### BACKGROUND

Self-serve or self-checkout retail models have gained their popularity in our modern society. As an alternative and replacement to the traditional cashier-staffed checkout, self-checkout machines are playing an increasingly important role for retail success, particularly for grocery stores and supermarkets.

Beyond self-checkout machines, more advanced self-serve or self-checkout retail models have been proposed in recent years. By way of example, automated stores supposed to operate on computers and robotics. Unmanned stores, unlike automated stores, would rely on smartphone-related technologies and artificial intelligence to provide a type of self-serve and self-checkout customer experience.

Compared to the cashier-staffed retail model, many self-serve or self-checkout retail models face pronounced challenges in multiple fronts, including the precision for transaction recognition and the vulnerability for retail shrinkage. Technical solutions are needed to improve transaction recognition and loss prevention technologies.

### SUMMARY

This Summary is provided to introduce selected concepts that are further described below in the Detailed Description. This Summary is not intended to identify key features or essential features of the claimed subject matter, nor is it intended to be used as an aid in determining the scope of the claimed subject matter.

In general, aspects of this disclosure include technical applications for visual object tracking technologies, e.g., based on attention networks and other technologies. In one technical application, a shopping cart and products loaded into the shopping cart are visually identified and tracked, so a load-and-go retail model may be implemented. In another technical application, a customer's hand and a product are tracked in images. The co-location information of the customer's hand and the product are used to determine the type of retail event associated with the product, e.g., regular or irregular. In yet another technical application, the tracked location information of a product is compared with a predetermined area to determine the type of retail event associated with the product.

Further, to improve conventional tracking technologies, a deformable Siamese attention network is disclosed to improve the feature learning capability of Siamese-based trackers. A new attention technology is introduced to compute deformable self-attention and cross-attention. The self-attention technique learns strong context information via spatial attention, and selectively emphasizes interdependent channel-wise features with channel attention. The cross-attention technique aggregates rich contextual interdependencies between the target template and the search image, providing an implicit manner to adaptively update the target template via the computed Siamese attention. Additionally, a new region refinement technology is disclosed to improve the tracking accuracy, e.g., by computing depth-wise correlations between the attentional features.

In various aspects, systems, methods, and computer-readable storage devices are provided to improve a computing system's ability for visual object tracking in general. Specifically, one aspect of the technologies described herein is to improve a computing system's precision and robustness for tracking an object with an arbitrary shape, e.g., with a bounding box or an accurate mask of the object. Another aspect of the technologies described herein is to improve a computing system's functions to complete a computer-vision-based transaction, e.g., with a visually tracked shopping cart and products loaded to the shopping cart. Yet another aspect of the technologies described herein is to enable a computing system to perform various loss prevention functions, e.g., by tracking various objects in the retail environment.

### BRIEF DESCRIPTION OF THE DRAWINGS

The technologies described herein are illustrated by way of example and not limited in the accompanying figures in which like reference numerals indicate similar elements and in which:

FIG. 1 is a schematic representation illustrating an exemplary open retail system, following at least one aspect of the technologies described herein;

FIG. 2 is a schematic representation illustrating several object tracking examples in an exemplary open retail system, following at least one aspect of the technologies described herein;

FIG. 3 is a schematic representation illustrating an exemplary tracking system with an exemplary checkout station, following at least one aspect of the technologies described herein;

FIG. 4 is a schematic representation illustrating several object tracking examples with a checkout machine, following at least one aspect of the technologies described herein;

FIG. 5 is a schematic representation illustrating an exemplary network architecture, following at least one aspect of the technologies described herein;

FIG. 9 is a schematic representation illustrating an exemplary attention module, following at least one aspect of the technologies described herein;

FIG. 7 is a flow diagram illustrating an exemplary tracking process, following at least one aspect of the technologies described herein;

FIG. 8 is a flow diagram illustrating another exemplary tracking process, following at least one aspect of the technologies described herein; and

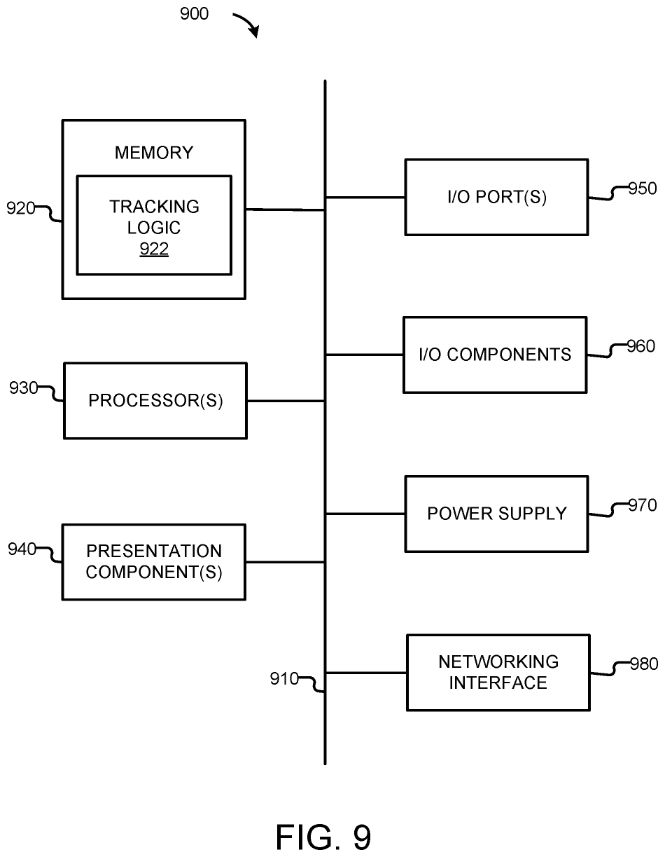

FIG. 9 is a block diagram of an exemplary computing environment suitable for use in implementing various aspects of the technologies described herein.

### DETAILED DESCRIPTION

The various technologies described herein are set forth with sufficient specificity to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Further, the term “based on” generally denotes that the succedent condition is used in performing the precedent action.

Self-serve or self-checkout retail models, e.g., self-checkout machines or cashier-less stores, have gained their popularity in our modern society. Self-checkout, also known as self-service checkout, is an alternative to the traditional cashier-staffed checkout, where self-checkout machines are provided for customers to process their purchases from a retailer. On the other hand, a cashier-less retail store may be partially or fully automated to enable customers to purchase products without being checked out by a cashier or even using a self-checkout machine.

Self-checkout machines can be used to complement or even replace traditional cashier-staffed checkout stations. A typical self-checkout machine has a lane light, a touchscreen monitor, a basket stand, a barcode scanner, a weighing scale, and a payment module. Using a self-checkout machine, a customer can scan product barcodes, weight products (such as fresh produce without barcodes) and select the product type on a display, pay the products, bag the purchased products, and exit the store without any interactions with a cashier or a clerk.

More advanced self-serve or self-checkout retail models have been proposed in recent years. By way of example, unmanned stores rely on smartphone-related technologies and artificial intelligence to provide a type of new shopping experience, in which customers may completely self-serve and self-checkout with a mobile app. To enable such new retail models, camera systems and machine learning models may be used to add products to a virtual shopping cart in the mobile app. Subsequently, the payment module in the mobile app may be used to finalize the retail transaction for the products in the virtual shopping cart. However, the cost to set up an experimental unmanned store today is prohibitive due to the sophisticated equipment and cumbersome technologies required to run such unmanned stores.

Self-serve or self-checkout retail models have other challenges. By way of example, conventional self-checkout machines can identify a product based on its barcode, but would certainly fail to identify any products skipping the scanning process. As another example, conventional unmanned stores are typically limited to be an individual experience, which is incompatible with a more desirable family or friends oriented social experience. For instance, a friend cannot add a product to another friend's virtual shopping cart in an unmanned store. However, it used to be routine for different family members to choose whatever they like and load the selected products into a common shopping cart in a traditional store. As yet another example, many customers are concerned about the privacy-agnostic technologies used in those new retail models as many experimental unmanned stores have to track customers' precise whereabouts, and some unmanned stores even utilize facial recognition technologies to track customers.

Although these new retail models provide the convenience for customers to walk out of the store with a bag of goods without interacting with a cashier, they generally are more vulnerable to shrinkage than the traditional cashier-staffed checkout process. Shrinkage is typically caused by deliberate or inadvertent human actions, and the majority of preventable loss in retail is caused by deliberate human actions. Inadvertent human actions, such as poorly executed business processes, may be mitigated by enacting or improving employee training and customer education. However, direct interventions are usually required to stop deliberate human actions, such as abuse, fraud, theft, vandalism, waste, or other misconduct leading to shrinkage. Studies suggest that a proportion of shoppers are tempted to commit the aforementioned misconduct due to the relative ease of doing so in the self-serve or self-checkout environment.

In this disclosure, technical solutions are provided to overcome some of the limitations of conventional self-serve or self-checkout systems, particularly to improve transaction recognition and loss prevention technologies. As used herein, transaction recognition refers to the technologies used to associate or disassociate a product with a transaction, e.g., adding a product to or removing the product from a virtual shopping cart or an account. Loss prevention refers to the technologies used to identify human actions leading to shrinkage. As used herein, legit transactional events, e.g., as determined by the disclosed transaction recognition technologies, are also categorized as the regular retail event type, or simply regular. Conversely, events leading to shrinkage may be categorized as the irregular retail event type, or simply irregular.

To achieve that, in a high level, the disclosed system uses various visual object tracking technologies to track, e.g., a hand, a product, a shopping cart, etc., and accordingly to perform transaction recognition tasks or loss prevention tasks based on the tracked location information or an object at a tracked location. In one technical application, a shopping cart and products loaded into the shopping cart are visually identified and tracked, so a load-and-go retail model may be implemented. In another technical application, a customer's hand and a product are tracked in images. The co-location information of the customer's hand and the product are used to determine the type of retail event associated with the product, e.g., regular or irregular. In yet another technical application, the tracked location information of a product is compared with a predetermined area to determine the type of retail event associated with the product.

Further, to improve conventional tracking technologies, deformable Siamese attention networks are disclosed to improve the feature learning capability of Siamese-based trackers. A new attention technology is introduced to compute deformable self-attention and cross-attention. The self-attention learns strong context information via spatial attention, and selectively emphasizes interdependent channel-wise features with channel attention. The cross-attention is designed to aggregate rich contextual interdependencies between the target template and the search image, providing an implicit manner to adaptively update the target template via the computed Siamese attention. A new region refinement technology is also disclosed to improve the tracking accuracy, e.g., by computing depth-wise correlations between the attentional features. Advantageously, with improved visual object tracking capabilities, the disclosed technologies are used to perform various practical applications related to transaction recognition and loss prevention.

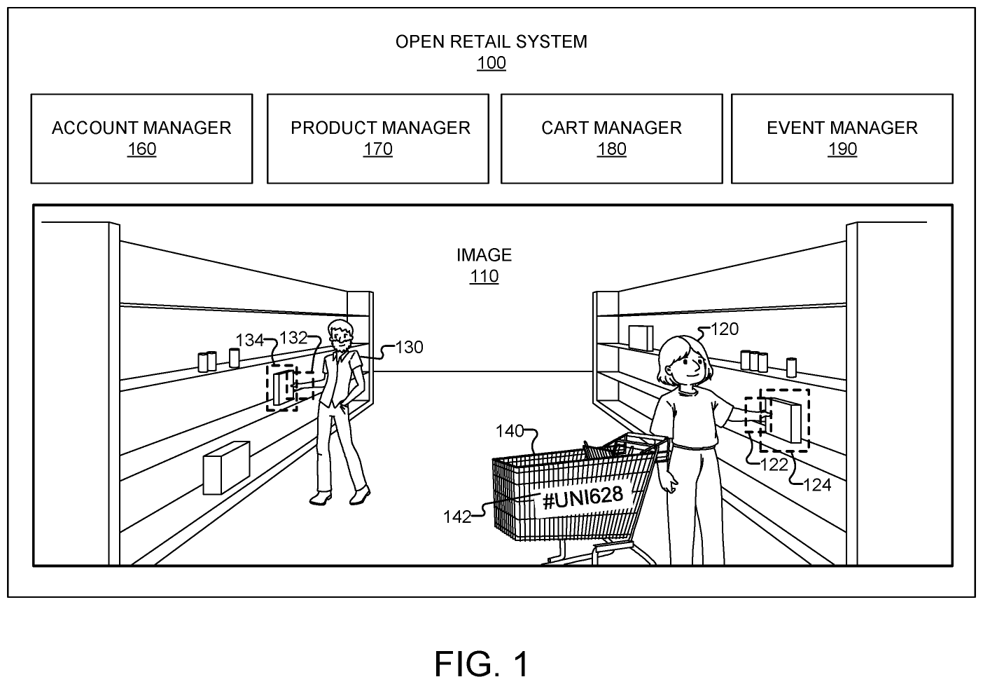

Having briefly described an overview of aspects of the technologies described herein, an exemplary open retail system (hereinafter “system 100”) is illustrated in FIG. 1. System 100 is a computer-vision-based self-serve or self-checkout retail system, which offers new load-and-go shopping experience for customers. By way of example, customer 120 and customer 130 can simply load all goods they choose to cart 140 and then walk out the shopping area to complete the purchase. Unique to system 100, retail transactions are centered at each unique shopping cart. Technically, system 100 is configured to identify and track each shopping cart based on computer vision technologies, so that retail transactions may be determined based on products loaded to a particular shopping cart. Advantageously, with system 100, customers can maintain their familiar shopping habits, such as loading products by family members or friends into a shopping cart, but without spending time to wait at the checkout line or to perform any tedious checkout process themselves.

In system 100, account manager 160 is configured to manager account information of customers, and in some embodiments, to associate an account with a shopping cart for a transaction. An account is to identify a shopping entity, e.g., a customer, an organization, etc., which has a payment method (e.g., a default credit card) as well as other account information (e.g., name, address, phone numbers, etc.) registered with a retailer. In some embodiments, to link an account with a shopping cart, the customer may scan a barcode (e.g., a quick response (QR) code) associated with the shopping cart with a mobile app. The barcode has the information of a unique cart identifier (e.g., cart identifier 142) to uniquely identify a particular shopping cart (e.g., cart 140). After reading the barcode, account manager 160 may then bind the account and the particular shopping cart in a transactional session. In some embodiments, account manager 160 also initiates a virtual shopping cart to mirror the physical shopping cart.

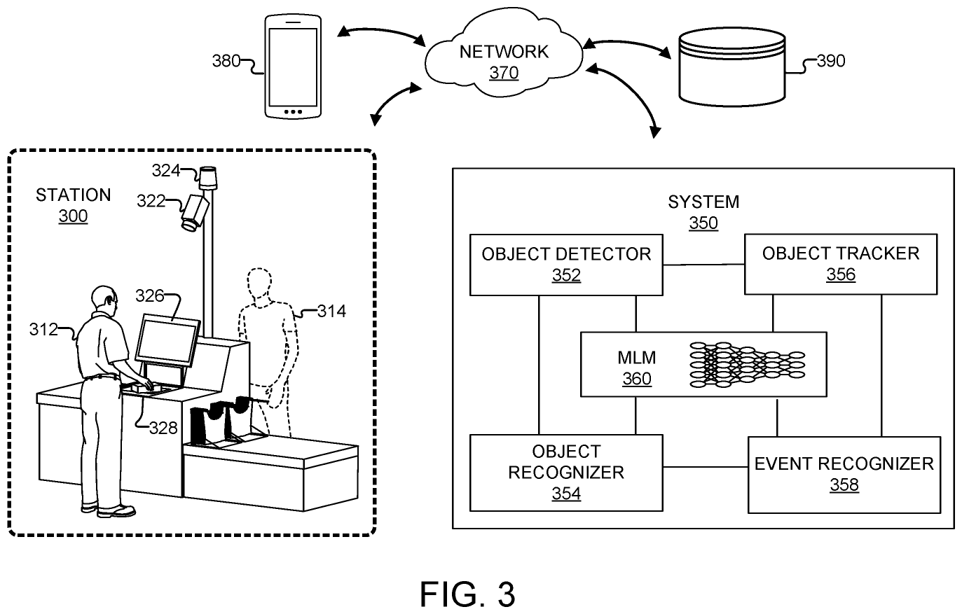

Product manager 170 is configured to manage product information, and in some embodiments, to recognize a product for a transaction. In various embodiments, product recognition is achieved with object recognizer 354 and MLM 360 in connection with FIG. 3. In various embodiments, product manager 170 is configured to recognize products being moved by customers or products being loaded into or unloaded from a shopping cart. In some embodiments, the product recognition process is activated when a product starts moving, e.g., picked up by a hand from a shelf or removed from a shopping cart. In some embodiments, the product recognition process is conducted when a product is loaded into a shopping cart, e.g., by detecting an additional product with the cart or detecting a tracked product “disappeared” into the cart, which will be further discussed in connection with other figures. Disappearance refers to the previously tracked object is no longer detected in an image.

Cart manager 180 is configured to manager cart-based transactions, and in some embodiments, to identify and track a cart as well as complete a payment for a product in a virtual shopping cart that corresponds to the physical cart, e.g., when the cart leaves the shopping zone. In various embodiments, cart manager 180 is to identify a cart visually, e.g., based on a unique cart identifier attached to the cart. In some embodiments, a cart identifier may be composed of a unique string of symbols, e.g., with letters, numbers, or special characters. In some embodiments, a cart identifier may be composed of unique graphical designs, such as a unique combination of colors or patterns. In other embodiments, other designs may be used to uniquely identify each of the carts in a store. For a multi-store retailer, the cart identifier may further include a unique store identifier.

In various embodiments, cart identifiers are configured to be visible to ceiling-mounted cameras. In this embodiment, cart identifier 142 is attached to multiple sides of cart 140. Specifically, the information of cart identifier 142 is duplicated in the multiple sides of cart 140, although the respective representations of cart identifier 142 may be different, e.g., in different sizes, fonts, orientations, etc. In this way, cart identifier 142 can remain in the light of sight of one or more cameras connected to system 100 even if one side of cart 140 may be blocked, e.g., by customer 120. In some embodiments, cart identifier 142 is configured to be raised above cart 140, e.g., by raising cart identifier 142 with a flagpole, so that cart identifier 142 can be more easily captured by one of the cameras connected to system 100. Advantageously, a retailer may easily and economically convert a regular shopping cart to a special cart useable in system 100, e.g., by simply attaching a cart identifier to the regular shopping cart. With the flag-like cart identifiers, virtually no modification is required, and customers can simply put a flag-like cart identifier to a regular shopping cart, so that system 100 can uniquely identify the shopping cart with computer vision technologies.

Different computer vision technologies may be used to recognize a unique cart identifier based on its symbology. In one embodiment, unique strings are used as cart identifiers. The character recognition technologies, as disclosed in U.S. application Ser. No. 16/672,883, may be used by cart manager 180 to recognize cart identifiers. In connection with machine learning model (MLM) 360 in FIG. 3, in some embodiments, cart manager 180 may use one or more convolutional networks to identify a position of a cart identifier from image 110 in the detection stage. For example, when image 110 fed into the convolutional networks, various feature maps may be generated to indicate a confidence measure for whether a cart identifier is presented and its position in the image. In the recognition stage, the cart identifier (e.g., a character string) may be recognized from the positions identified in the detection stage, e.g., based on a recursive-network-based approach or OCR-related technologies. In other embodiments, based on the specific symbology used for cart identifiers, e.g., color or pattern composition, different MLM suitable to the specific symbology may be used.

Event manager 190 is configured to determine an event type associated with a shopping cart or a product. In some embodiments, for a regular event, event manager 190 is further configured to add or remove a product to or from a virtual shopping cart based on the particular regular event type. For an irregular event, event manager 190 is further configured to perform corresponding loss prevention measures based on the particular irregular event type. Event manager 190 is further discussed in connection with system 350 in FIG. 3.

Referring back to image 110, in one embodiment, any moving products (e.g., a product moved from its previous position in a previous image) are tracked. If event manager 190 detects a regular event type (e.g., a moving product is added to or removed from cart 140 in a subsequent image), event manager 190 will cause the product to be added to or removed from the virtual shopping cart corresponding to cart 140.

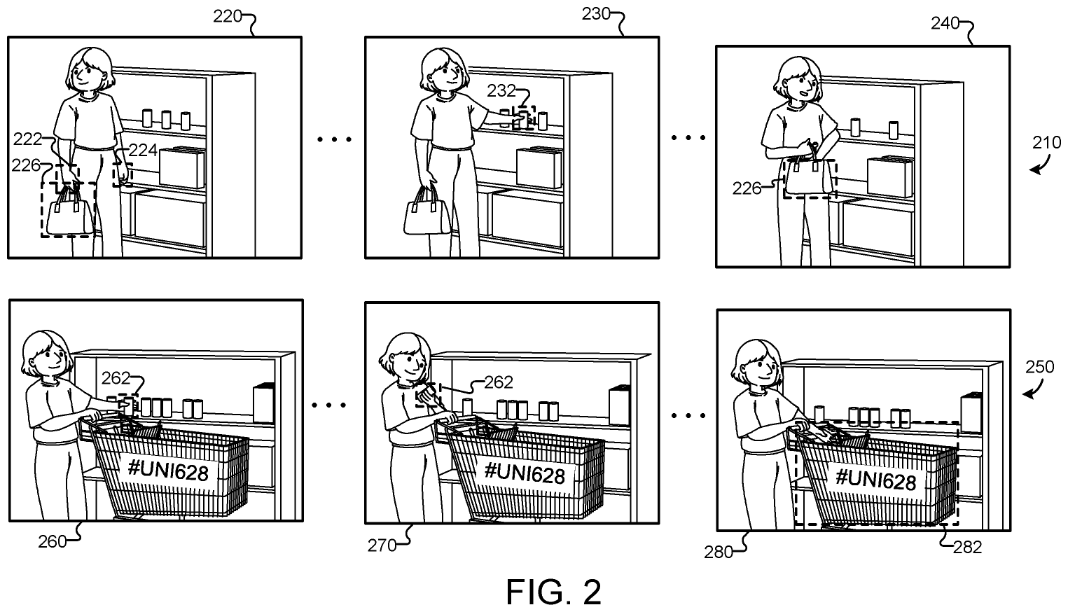

In another embodiment, locations of customers' hands are tracked. Subsequently, event manager 190 also tracks the product grabbed by a hand. For example, hand 122 is being tracked. When hand 122 grabs product 124, product manager 170 starts to recognize product 124. Similarly, hand 132 is also being tracked, and product manager 170 starts to recognize product 134 when it is grabbed by hand 132. By tracking both hands and products, event manager 190 can more accurately determine the product picked by a customer and additionally determine some regular or irregular event types, such as discussed in connection with FIG. 2.

When cart 140 leaves the shopping zone or area, alternatively, enters a designated payment zone, as detected from a subsequent image, account manager 160 may then conduct a payment based on the products in the virtual shopping cart, which mirror the actual products in cart 140. In some embodiments, the binding of cart 140 and the account used in the previous shopping session may be released. In some embodiments, such release will only be realized after the customer returns cart 140 to a designated cart-return zone or area.

In various embodiments, event manager 190 is not required to analyze the customers (particularly their faces) in image 110 to protect customer's privacy. Further, as system 100 is configured to conduct transactions based on unique carts instead of individual customers in these embodiments, both customer 120 and customer 130 may load or unload products to or from cart 140, just like family members or friends would do in their normal shopping trips. In terms of customer experience, the load-and-go retail models not only enable customers to skip the checkout line and save time but allow them to maintain their normal shopping habits.

FIG. 2 is a schematic representation illustrating several object tracking examples in an exemplary open retail system, as discussed in connection with FIG. 1. An event, as captured by a camera, usually consists of many consecutive frames or images. By analyzing the consecutive images, system 100 can track various objects detected in the images. In various embodiments, object tracking technologies are used to determine the type (e.g., regular or irregular) or a subtype (e.g., shoplifting, non-scan, etc. for an irregular type) of an event associated with the tracked object.

By way of example, shoplifting is a common action causing shrinkage. To identify a typical shoplifting action, one key observation is the person attempts to conceal a product. For the concealment, it is also advantageous to recognize the actual product and where it was concealed. Further, it is likely necessary to retain the evidence (e.g., the video or images showing the concealment) for loss prevention or loss recovery.

Referring now to sequence 210, which is a sequence of images illustrating an irregular event, specifically, a person is potentially trying to conceal a product. As will be discussed in further detail, in this embodiment, an object that is co-located with a hand will be tracked. Collocation refers to the bounding boxes of two objects having at least a partial overlap, e.g., when the overlap ratio for the smaller bounding box is greater than a threshold.

Here, image 220 illustrates that there are three objects are being tracked, namely, hand 222, hand 224, and handbag 226. In image 230, hand 222, hand 224, and handbag 226 are still being tracked, and their bounding boxes are omitted to simplify the figure. Instead, image 230 illustrates that the system starts to track product 232 additionally based on the collocation of hand 224 and product 232. The system will continue to track hand 224 and product 232 till a special event, such as a separation of hand 224 and product 232, or a disappearance of product 232. In image 240, the system cannot track product 232 anymore as the person conceals product 232 into handbag 226. In this embodiment, as handbag 226 is outside of a set of regular object (e.g., cart 282), the system would determine an irregular event being observed with product 232, accordingly execute one or more loss-prevention actions, such as generating an alert and distribute the alert to a loss-prevention person. The alert may include one or more key images, such as image 230 and image 240. This process is further discussed in connection with process 700 in FIG. 7.

For loss prevention or recovery, a key observation is about a person entering a store or a particular area. Conversely, another key observation is about the same person leaving the store or a particular area. In some embodiments, the system will model objects brought into a store by a customer, and label those objects, e.g., as irregular objects. For instance, a bag may be detected in the image showing the person carrying the bag into the store. The bag's image features may be learned from a MLM. Such image features may serve as the fingerprint of this bag. Similarly, in sequence 210, image features of handbag 226 may be learned from the MLM. If the similarity between the image features of handbag 226 and the image features of the bag detected at the store entrance is greater than a threshold, the system may then recognize handbag 226 as the bag detected at the store entrance. To provide additional information for loss prevention or recovery, the system may additionally deliver the image showing the bag detected at the store entrance along with image 240 to the loss prevention person.

Referring now to sequence 250, in contrast, sequence 250 is a sequence of images illustrating a regular event when a person is loading a product to a system-recognized shopping cart. In image 260, like in image 230, the system starts to track product 262 when the person grabs product 262 from a shelf. In image 270, product 262 is still being tracked. However, in image 280, product 262 disappears, and the system loses the track. Meanwhile, cart 282 is detected and recognized at the location of (product 262's) disappearance. As cart 282 is a system-recognized regular object, the system would classify the event in sequence 250 as regular. Further, the system may add product 262 to the virtual shopping cart corresponding to cart 282. This process is further discussed in connection with process 700 in FIG. 7.

FIG. 3 is a schematic representation illustrating an exemplary tracking system (system 350) used for an exemplary checkout station (station 300). It should be noted that station 300 and system 350 here merely illustrate some examples following at least one aspect of the technologies described herein. Station 300 or system 350 is not intended to suggest any limitation as to the scope of use or functionality of all aspects of the technology described herein. Neither should one component in station 300 or system 350 be interpreted as having any inseparable dependency on another component or any combination of components thereof.

In this embodiment, station 300 includes, among many components not shown, scanner 328 and display 326. User 312 may use this checkout station for self-checkout or to assist others (e.g., user 314) checkout products. Camera 322 is configured to monitor station 300, particularly the area above scanner 328. Further, light 324 may be activated if an irregular event is detected by system 350. Meanwhile, a message (e.g., including one or images representing the irregular event) may be generated and delivered to mobile device 380, which could be a mobile phone of a loss prevention person. In some embodiments, system 350 is installed in station 300. In some embodiments, system 350 is located remotely and operatively coupled to station 300, e.g., via network 370, which may include, without limitation, a local area network (LAN) or a wide area network (WAN), e.g., one or more 4G or 5G cellular networks.

At a high level, system 350 is configured for object tracking. In one embodiment, the system is to analyze images captured by camera 322 and to track one or more objects in these images, e.g., using various computer vision technologies. Further, based on such object tracking, system 350 determines the event type (e.g., regular or irregular) or the event subtype (e.g., a specific irregular subtype) associated with a tracked object (e.g., a product). In another embodiment, system 350 analyzes images captured by other store cameras (not shown) and tracks a shopping cart and products loaded into the shopping cart. System 350 may then determine the event type or subtype associated with each interaction between the cart and a product. In some embodiments, event manager 190 in system 100 uses system 350 to determine event type or subtype associated with an interaction between a cart and a product, or between a hand and a product.

In addition to other components not shown, object detector 352, object recognizer 354, object tracker 356, and machine learning model (MLM) 360, operatively coupled with each other to achieve various functions of system 350. In various embodiments, object detector 352 detects objects in an image, and object recognizer 354 recognizes the detected objects, e.g., via one or more MLMs in MLM 360. In retail-related applications, the one or more MLMs are configured to recognize learn product features and compare them for similarities. The applications (PCT/CN2019/111643, PCT/CN2019/086367) have disclosed some effective technical solutions for product detection or recognition, which may be used by object detector 352 or object recognizer 354. Various detectors may be used, such as two-stage detectors (e.g., Faster-RCNN, R-FCN, Lighthead-RCNN, Cascade R-CNN, etc.) or one-stage detectors (e.g., SSD, Yolov3, RetinaNet, FCOS, EfficientDet, etc.). Various networks (e.g., VGG, ResNet, Inception, EfficientNet) with different types of losses (e.g., triplet loss, contrastive loss, lifted loss, multi-similarity loss, etc.) may be used for product feature learning and comparison. Further details of MLMs will be discussed in connection with MLM 360 herein.

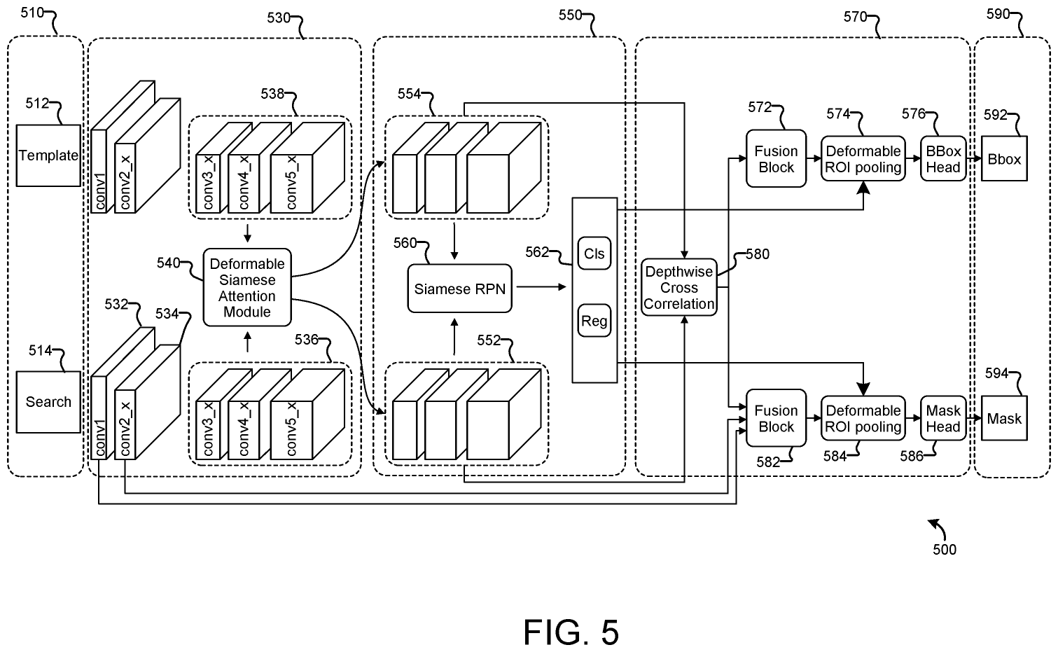

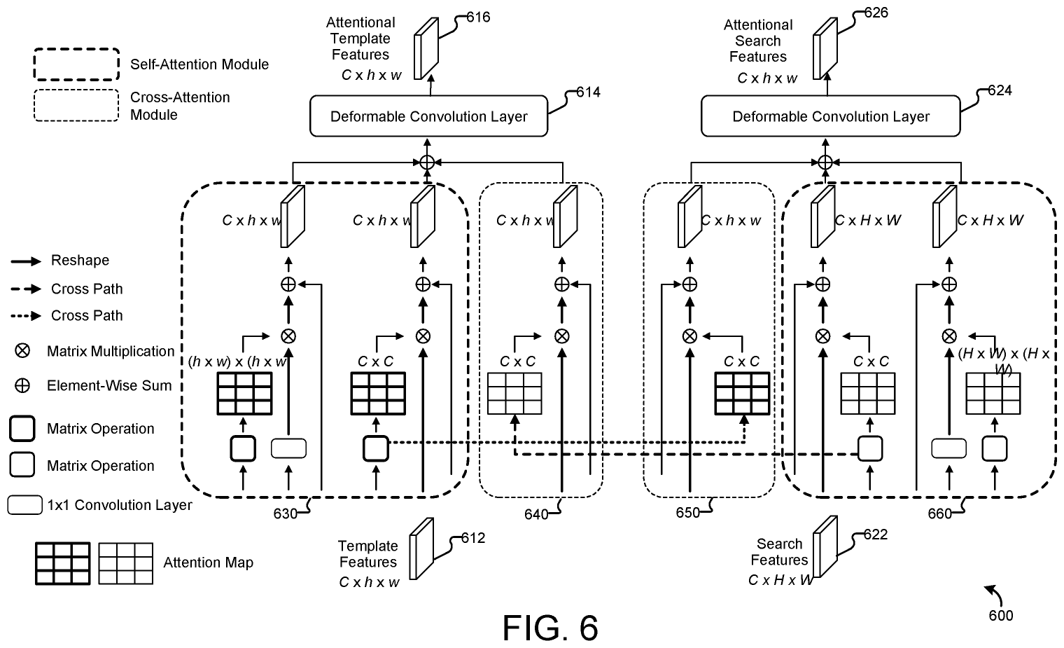

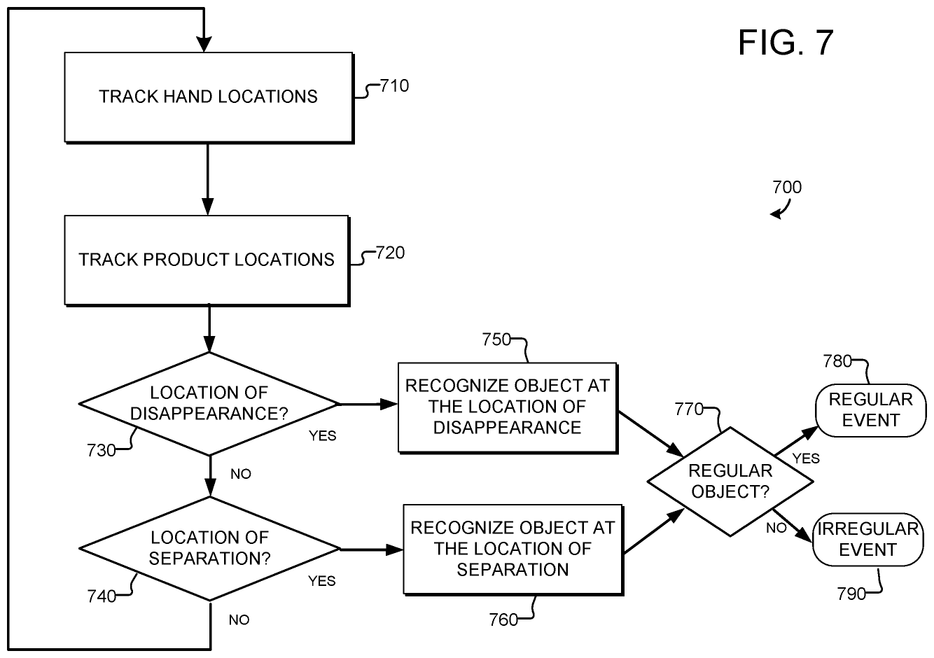

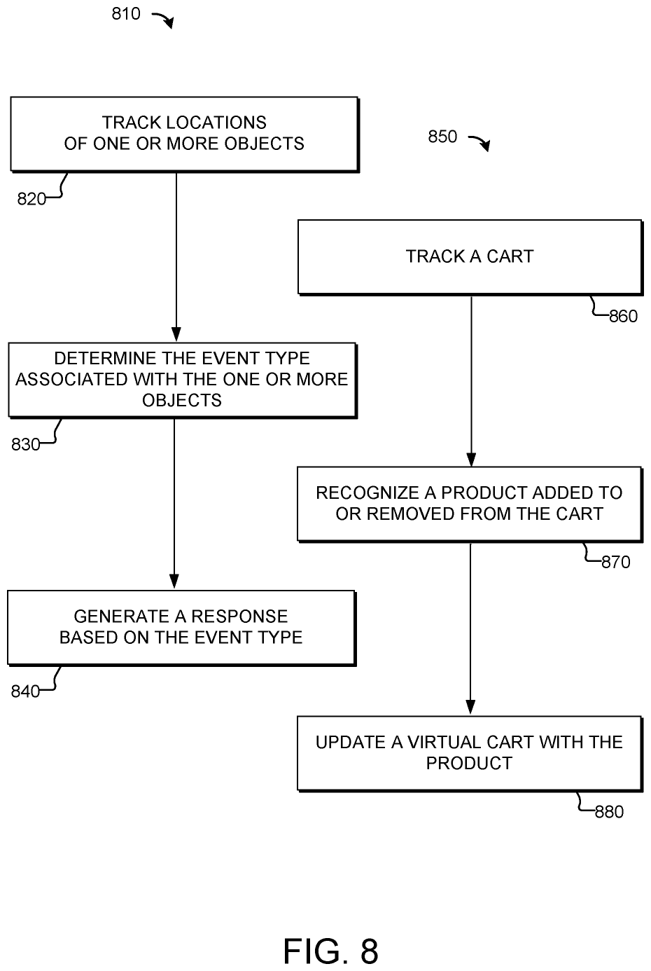

Object tracker 356 is configured to track a target object at each image over a sequence of images. In various embodiments, a bounding box of the target object is one of the output from object tracker 356. Siamese networks are useful for visual tracking. In various embodiments, object tracker 356 utilized network 500 in FIG. 5 for visual tracking. Network 500 uses deep learning technologies to learn powerful feature representations, which will be further discussed in connection with FIGS. 5-6.

Returning to the machine learning models, the aforementioned many computer vision technologies may be implemented in MLM 360, which may include one or more neural networks in some embodiments. Different components in system 350 may use one or more different neural networks to achieve their respective functions, which will be further discussed in connection with the remaining figures. For example, object recognizer 354 may use a trained neural network to learn the neural features of an unknown product, which may be represented by a feature vector in a high-dimensional feature space, and compute the similarity between the unknown product and a known product based on the cosine distance between their respective feature vectors in the high-dimensional feature space. In various embodiments, various MLMs and image data (e.g., image data captured by camera 322, product data associated with the high-dimensional feature space, etc.) may be stored in data store 390 and accessible in real-time via network 370.

As used herein, a neural network comprises at least three operational layers. The three layers can include an input layer, a hidden layer, and an output layer. Each layer comprises neurons. The input layer neurons pass data to neurons in the hidden layer. Neurons in the hidden layer pass data to neurons in the output layer. The output layer then produces a classification. Different types of layers and networks connect neurons in different ways.

Every neuron has weights, an activation function that defines the output of the neuron given an input (including the weights), and an output. The weights are the adjustable parameters that cause a network to produce a correct output. The weights are adjusted during training. Once trained, the weight associated with a given neuron can remain fixed. The other data passing between neurons can change in response to a given input (e.g., image).

The neural network may include many more than three layers. Neural networks with more than one hidden layer may be called deep neural networks. Example neural networks that may be used with aspects of the technology described herein include, but are not limited to, multilayer perceptron (MLP) networks, convolutional neural networks (CNN), recursive neural networks, recurrent neural networks, and long short-term memory (LSTM) (which is a type of recursive neural network). Some embodiments described herein use a convolutional neural network, but the disclosed technologies apply to other types of multi-layer machine classification models.

A CNN may include any number of layers. The objective of one type of layers (e.g., Convolutional, Relu, and Pool) is to extract features of the input volume, while the objective of another type of layers (e.g., fully connected (FC) and Softmax) is to classify based on the extracted features. An input layer may hold values associated with an instance. For example, when the instance is an image(s), the input layer may hold values representative of the raw pixel values of the image(s) as a volume (e.g., a width, W, a height, H, and color channels, C (e.g., RGB), such as W×H×C), or a batch size, B.

One or more layers in the CNN may include convolutional layers. The convolutional layers may compute the output of neurons that are connected to local regions in an input layer (e.g., the input layer), each neuron computing a dot product between their weights and a small region they are connected to in the input volume. In a convolutional process, a filter, a kernel, or a feature detector includes a small matrix used for feature detection. Convolved features, activation maps, or feature maps are the output volume formed by sliding the filter over the image and computing the dot product. An exemplary result of a convolutional layer may include another volume, with one of the dimensions based on the number of filters applied (e.g., the width, the height, and the number of filters, F, such as W×H×F, if F were the number of filters).

One or more of the layers may include a rectified linear unit (ReLU) layer. The ReLU layer(s) may apply an elementwise activation function, such as the max (0, x), thresholding at zero, for example, which turns negative values to zeros (thresholding at zero). The resulting volume of a ReLU layer may be the same as the volume of the input of the ReLU layer. This layer does not change the size of the volume, and there are no hyperparameters.

One or more of the layers may include a pooling layer. A pooling layer performs a function to reduce the spatial dimensions of the input and control overfitting. This layer may use various functions, such as Max pooling, average pooling, or L2-norm pooling. In some embodiments, max pooling is used, which only takes the most important part (e.g., the value of the brightest pixel) of the input volume. By way of example, a pooling layer may perform a down-sampling operation along the spatial dimensions (e.g., the height and the width), which may result in a smaller volume than the input of the pooling layer (e.g., 16×16×12 from the 32×32×12 input volume). In some embodiments, the convolutional network may not include any pooling layers. Instead, strided convolutional layers may be used in place of pooling layers.

One or more of the layers may include a fully connected (FC) layer. An FC layer connects every neuron in one layer to every neuron in another layer. The last FC layer normally uses an activation function (e.g., Softmax) for classifying the generated features of the input volume into various classes based on the training dataset. The resulting volume may take the form of 1×1×number of classes.

Further, calculating the length or magnitude of vectors is often required either directly as a regularization method in machine learning, or as part of broader vector or matrix operations. The length of the vector is referred to as the vector norm or the vector's magnitude. The L1 norm is calculated as the sum of the absolute values of the vector. The L2 norm is calculated as the square root of the sum of the squared vector values. The max norm is calculated as the maximum vector values.

As discussed previously, some of the layers may include parameters (e.g., weights or biases), such as a convolutional layer, while others may not, such as the ReLU layers and pooling layers, for example. In various embodiments, the parameters may be learned or updated during training. Further, some of the layers may include additional hyper-parameters (e.g., learning rate, stride, epochs, kernel size, number of filters, type of pooling for pooling layers, etc.), such as a convolutional layer or a pooling layer, while other layers may not, such as a ReLU layer. Various activation functions may be used, including but not limited to, ReLU, leaky ReLU, sigmoid, hyperbolic tangent (tanh), exponential linear unit (ELU), etc. The parameters, hyper-parameters, or activation functions are not to be limited and may differ depending on the embodiment.

Although input layers, convolutional layers, pooling layers, ReLU layers, and fully connected layers are discussed herein, this is not intended to be limiting. For example, additional or alternative layers, such as normalization layers, Softmax layers, or other layer types, may be used in a CNN.

Different orders and layers in a CNN may be used depending on the embodiment. For example, when system 350 is used in practical applications for loss prevention (e.g., with emphasis on detecting irregular checkout events at a POS), there may be one order and one combination of layers; whereas when system 350 is used in practical applications for enabling an open retail system (e.g., with emphasis on the interaction between a cart and a product), there may be another order and another combination of layers. In other words, the layers and their order in a CNN may vary without departing from the scope of this disclosure.

Although many examples are described herein concerning using neural networks, and specifically convolutional neural networks, this is not intended to be limiting. For example, and without limitation, MLM 360 may include any type of machine learning models, such as a machine learning model(s) using linear regression, logistic regression, decision trees, support vector machines (SVM), Naïve Bayes, k-nearest neighbor (KNN), K means clustering, random forest, dimensionality reduction algorithms, gradient boosting algorithms, neural networks (e.g., auto-encoders, convolutional, recurrent, perceptrons, long or short term memory/LSTM, Hopfield, Boltzmann, deep belief, deconvolutional, generative adversarial, liquid state machine, etc.), or other types of machine learning models.

System 350 is merely one example of a suitable computing environment and is not intended to suggest any limitation as to the scope of use or functionality of aspects of the technologies described herein. Neither should this system be interpreted as having any dependency or requirement relating to any one component nor any combination of components illustrated.

It should be understood that this arrangement of various components in system 350 is set forth only as an example. Other arrangements and elements (e.g., machines, networks, interfaces, functions, orders, and grouping of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by an entity may be carried out by hardware, firmware, or software. For instance, some functions may be carried out by a processor executing instructions stored in memory.

It should be understood that each of the components shown in system 350 may be implemented on any type of computing device, such as computing device 900 described in FIG. 9. Further, each of the components may communicate with various external devices via a network, which may include, without limitation, a local area network (LAN) or a wide area network (WAN).

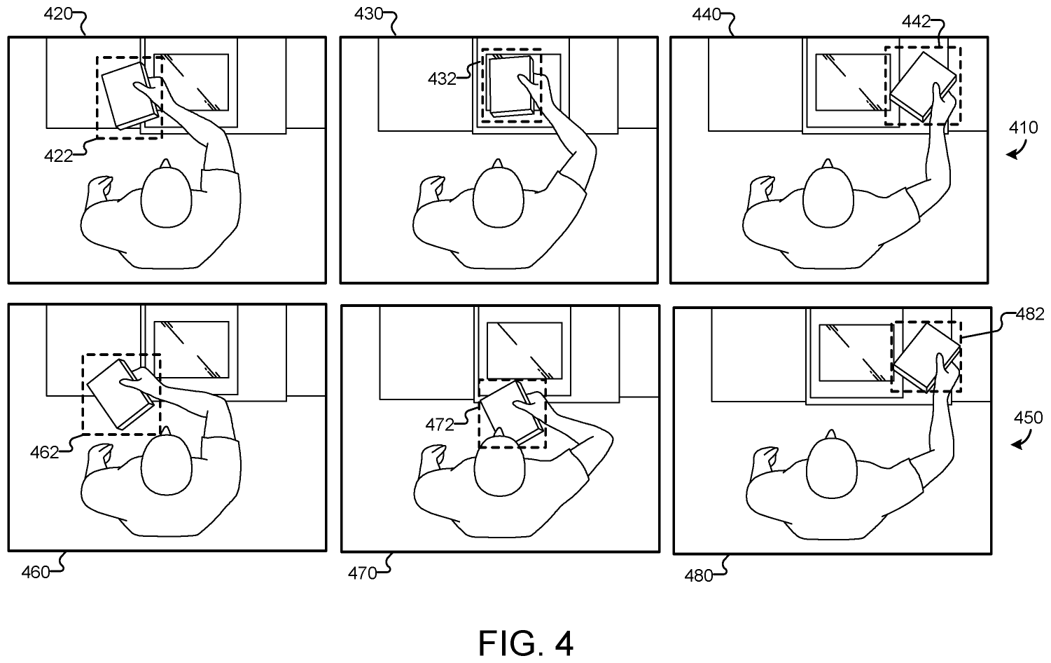

FIG. 4 is a schematic representation illustrating several object tracking examples during a checkout process, e.g., in connection with station 300 in FIG. 3. As discussed previously, a conventional checkout machine cannot detect non-scan products, e.g., due to inadvertent or intentional behavior, when the scanner fails to read the barcode on the product. This is another common phenomenon causing shrinkage. System 350 is configured to detect non-scan events with station 300. One indication for a typical non-scan event is the product has bypassed the scanner (e.g., an effective scan area of the scanner) during the checkout process.

Referring now to sequence 410, which is a sequence of images illustrating a regular scan event, where a product is tracked. In image 420, the tracking process detects the product at position 422 left of the scanner. In image 430, the tracking process detects the product at position 432 above the scanner. In image 430, the tracking process detects the product at position 432 right of the scanner. The area of a bounding box, which indicates a position of the product, may be compared with the effective scan area of the scanner. In some embodiments, if the overlap ratio of these two areas is greater than a threshold, system 350 would determine the event type associated with the product to be regular; otherwise, irregular. Hereinafter, this is referred to as the overlap test. In one embodiment, the threshold is very low (e.g., 0.01), so that a low overlap ratio is sufficient for the event to be classified as regular.

In contrast, in sequence 450, although position 462 in image 460 is similar to position 422 in image 420, and position 482 in image 480 is similar to position 442 in image 440, position 472 in image 470 would run afoul the overlap test. As the area indicated by the bounding box of position 472 does not overlap with the effective scan area of the scanner, system 350 would determine the event type associated with the product to be irregular. In this case, the user likely failed to correctly scan the product.

FIG. 5 is a schematic representation illustrating an exemplary network architecture (hereinafter “network 500”) for visual object tracking, which aims to track a given target object at each frame in a video. Network 500 is designed to improve the performance of visual object trackers by providing the strong capacity of learning powerful feature representations, even if the image has a complex background, or the tracked objects in the image have complications of deformations, motions, occlusions, etc.

Siamese-based trackers formulate the visual object tracking as a matching problem by computing cross-correlation similarity between the target template and the search region, which transforms the tracking problem into finding an image region having the highest visual similarity with the target object. Traditional Siamese-based trackers are trained completely offline by using massive frame pairs collected from videos, and thus the target template cannot be updated online. This makes it difficult to precisely track the targets with large appearance variations, significant deformations, or occlusions, which inevitably increase the risk of tracking drift. Furthermore, the convolutional features of the target object and the search image are computed independently in traditional Siamese architecture, where the background information is completely discarded in the target features. However, the background information can be important to distinguish the target from close distractors and complex backgrounds. Some recent works attempt to enhance the target representation by integrating the features of previous targets, but still fail to use the discriminative context information from the background.

Traditional Siamese-based trackers do not have strong target-discriminability and can be easily affected by distractors with complex backgrounds. Network 500 improves the feature learning capability of Siamese-based trackers. Further, network 500 has a new deformable Siamese attention, which can improve the target representation with stronger robustness to large appearance variations, and also enhance the target discriminability against distractors and complex background, resulting in more accurate and stable tracking. To this end, network 500 fully explores the potentials of feature attentions in Siamese networks, and makes use of both self-attention and cross-branch attention jointly with deformable operations, and thus can significantly enhance the discriminative capability for learning target representation.

At a conceptual level, network 500 formulates visual object tracking as a similarity learning problem. Network 500 locates a target object, denoted as z, within a larger search image, denoted as x. Network 500 uses a pair of CNN branches with sharing parameters 0, which are used to project a target image and a search image into a common embedding space, where a similarity metric g can be computed to measure the similarity between them, g(ϕ(x),ϕ(z)). More specifically, network 500 extracts deep features from the target image and the search image, denoted as ϕ(x) and ϕ(z), which are then fed into a region proposal framework, which has two branches, for classification and bounding box regression.

At an architectural level, network 500 includes feature generation block (FGB) 530, region proposal block (RPB) 550, and region refinement block (RRB) 570 in this embodiment. From input block 510, a target template (template 512) and a search image (search 514) are fed into FGB 530. In some embodiments, FGB 530 uses ResNet-50 as the backbone and contains five stages, which extract increasing high-level features when layers go deeper. The features of the last three stages (i.e., features 538 and features 536) are extracted and then modulated by deformable Siamese attention module (DSAM) 540, which generates two-stream attentional features, features 554 and features 552, based on features 538 and features 536 respectively.

The attentional features are fed into Siamese region refinement network (SRPN) 560. SRPN 560 takes a pair of convolutional features computed from the two branches of Siamese networks and outputs dense prediction maps, including a set of target proposals with corresponding bounding boxes and class scores. Each spatial position on a dense prediction map has several anchors with various aspect ratios. The dense prediction maps are further processed by a classification head and a bounding box regression head in selection module 562 to generate a final tracking region. In one embodiment, SRPN 560 generates three prediction maps which are then combined by weighted sum. Each spatial position in the combined prediction map predicts a set of region proposals (e.g., corresponding to the pre-defined anchors), with corresponding classification scores and bounding boxes. Then the predicted proposal with the highest classification score is selected as the final tracking region.

However, the final tracking region may not fit the tracked object exactly. To improve the prediction accuracy, the final tracking region can be further refined at RRB 570, where depth-wise cross-correlation 580 is computed on the two-stream attentional features. The correlated features are further fused and enhanced, and then are used for refining the tracking region via joint bounding box regression and target mask prediction. Finally, bounding box 592 and mask 594 are generated at output block 590.

In one embodiment, depth-wise cross-correlation 580 is applied between the attentional template features and the attentional search features to generate multiple correlation feature maps. Then the generated correlation feature maps are fed into fusion block 572 and fusion block 582 respectively, where the feature maps with different sizes are aligned in both spatial and channel domains. For example, the features with low-resolution are up-sampled, while the features with high-resolution are down-sampled to the same scale. Then a 1×1 convolution is applied to the spatially aligned features to further align them in channel dimension. Finally, all aligned features are subsequently fused by an element-wise sum operation.

To improve the tracking accuracy, RRB 570 predicts both bounding box 592 and mask 594 of the target on the fused features. To compute the features of the target more precisely, RRB 570 has several additional operations. Convolutional features 532 and convolutional features 534 from the first two-stages are further added into the fused features at fusion block 582. This operation encodes richer local detailed information for mask prediction. Further, deformable region of interest (ROI) pooling 574 and deformable ROI pooling 584 are applied to compute target features more accurately. Further, in bounding box head 576 and mask head 586, different spatial resolutions may be used for mask prediction (e.g., 64×64) and bounding box regression (e.g., 25×25) to generate the convolutional features as the tasks of bounding box regression and mask prediction often require different levels of convolutional features.

In one embodiment, the resolution of input for bounding box head 576 is 4×4. By using two fully-connected layers with 512 dimensions, bounding box head 576 predicts a 4-tuple t=(tₓ, t_{y}, t_{w}, tₕ). Similarly, the input of mask head 586 has a spatial resolution of 16×16. By using four convolutional layers and a de-convolutional layer, mask head 586 predicts a class-agnostic binary mask (e.g., 64×64) for the tracking object. In various embodiments, RRB 570 does not have a classification head since visual object tracking is a class-agnostic task.

Network 500 may be trained in an end-to-end fashion. In one embodiment, the training loss is a weighted combination of multiple functions as shown in Eq. 1

L=L_{rpn-cls}+λ₁L_{rpn-reg}+λ₂L_{refine-box}+λ₃L_{refine-mask} (Eq.1)

L_{rpn-cls} is and L_{rpn-reg} refer to anchor classification loss and regression loss in SRPN 560, and a negative log-likelihood loss and a smooth L1 loss may be employed for L_{rpn-cls} is and L_{rpn-reg} correspondingly. L_{refine-box} and L_{refine-mask} indicate a smooth L1 loss for bounding box regression and a binary cross-entropy loss for mask segmentation in RRB 570. The weight parameters λ₁, λ₂ and λ₃ are used to balance the multiple tasks, which is empirically set to 0.2, 0.2 and 0.1 in one implementation.

Network 500 translates the tracking problem into a region proposal network (RPN) based detection framework by improving Siamese networks. Particularly, DSAM 540 includes both self-attention and cross-attention, which will be further discussed in FIG. 6, to enhance target discriminability and improve the robustness against large appearance variations, complex background, and distractors. RRB 570 can further increase the tracking accuracy by computing depth-wise correlations between the attentional features. This further enhances feature representations, leading to more accurate tracking by generating both the bounding box and mask of the object. Experimentally, network 500 achieves new state-of-the-art results on various benchmarks and outperforms recent strong baseline by a large margin while running at a real-time speed.

FIG. 6 is a schematic representation illustrating an exemplary attention module (hereinafter “module 600”). Previously, the attention and deep features of the target template and the search image are computed separately. Module 600 is designed to improve tracking performance on both accuracy and robustness by enhancing the learned discriminative representations of the target object and the search image. Module 600 introduces a new Siamese attention mechanism that encodes rich background context into the target representation by computing cross-attention in the Siamese networks. Specifically, this new Siamese attention mechanism computes deformable self-attention and cross-attention. The self-attention learns rich context information via spatial attention, and selectively enhance interdependent channel-wise features with channel attention. The cross-attention aggregates meaningful contextual interdependencies between the target template and the search image, which are encoded into the target template adaptively to improve discriminability. Various experiments suggest that the cross-attention component makes a great contribution to enhance the robustness and accuracy of the tracking results. When combining self-attention and cross-attention, the disclosed Siamese attention becomes more robust and also more accurate.

Module 600 takes template features and search features as input, and outputs corresponding attentional features. The input to module 600 includes a pair of convolutional feature maps (features 612 and features 622) of the target image and the search image, which are computed from Siamese networks. The output from module 600 includes the modulated features (features 616 and features 626) after applying the disclosed attention mechanism to the input. The feature maps of the target image and the search image may be denoted as Z and X, with feature sizes of C×h×w and C×H×W, respectively.

Module 600 has two types: self-attention sub-module (SASM), e.g., SASM 630 or SASM 660, and cross-attention sub-module (CASM), e.g., CASM 640 or CASM 650. Self-attention learns strong context information via spatial attention, and selectively emphasizes interdependent channel-wise features with channel attention. The cross-attention aggregates rich contextual interdependencies between the target template and the search image.

SASM 630 or SASM 660 attends to two aspects, namely channels and spatial positions. Unlike classification or detection tasks where object classes are pre-defined, visual object tracking is a class-agnostic task that the class of object is defined at the first frame and then fixed during the whole tracking process. As each channel map of the high-level convolutional features usually responses for a specific object class. Equally treating the features across all channels might hinder the representation ability. Similarly, as limited by receptive fields, the features computed at each spatial position of the convolutional maps can only capture the information from a local patch. Therefore, module 600 is designed to learn the global contextual information from the whole image.

Self-attention is calculated on the top of convolutional maps computed from the target image and the search image. It is computed separately on the target branch or the search branch, and both channel self-attention and spatial self-attention are computed in each branch. Taking the spatial self-attention for example, suppose the input features are X∈ [symbol] ^{C×H×W}. In some embodiments, two convolution layers with 1×1 kernels are applied on X to generate query features Q and key features K, where Q, K Q, K ∈ [symbol] ^{C′×H×W} and C′=1/8C is the reduced channel number. The two features are then reshaped to Q̅, K̅ ∈ [symbol] C^{′×N} where N=H×W. Spatial self-attention map A_{S}^{S}=∈ [symbol] ^{N×N} may be further generated via matrix multiplication between Q̅^{T} and K̅, and by applying Softmax operation column by column, e.g., based on Eq. 2

A_{S}^{S}=Softmax_{col}(Q̅^{T}K̅)∈ [symbol] ^{N×N} (Eq. 2)

Meanwhile, a convolution operation with reshape may be applied to features X to generate value features ∇∈ [symbol] ^{C×N}. The value features are multiplied with the attention maps to obtain the attended features, which are then added with a residual path as shown in Eq. 3, where a is a scalar parameter. The outputs are then re-shaped back to the original feature sizes as X_{S}^{S}=∈ [symbol] ^{C×H×W}.

X̅_{S}^{S}=aV̅A_{S}^{S}+X̅∈ [symbol] ^{C×N} (Eq.3)

Similarly, one can compute channel self-attention A_{C}^{S} and generate the channel attentional features X_{C}^{S}. Notice that on the channel self-attention and the corresponding attentional features, the query, key, and value features are the original convolutional features computed directly from the Siamese networks, without implementing 1×1 convolutions. The final self-attentional features X^{S} can be generated by combining the spatial and channel-wise attentional features using an element-wise sum.

Siamese networks usually make predictions in the last stage while the features from two branches flow separately. However, the content computed from two branches is critical to each other, especially when tracking visual object it is common that multiple objects appear at the same time, even with occlusions.

The cross-attention sub-modules are designed to learn mutual information from two Siamese branches, allowing them to compensate strongly to each other. Specifically, the search branch is to learn the target information, thus generating a more discriminative representation for accurately identifying the target. Similarly, the target representation is made more meaningful when the target branch learns the contextual information from the search image.

Specifically, by following the previous discussion, Z ∈ [symbol] ^{C×h×w} and X ∈ [symbol] ^{C×H×W} are used to denote template features and search features, respectively. Taking the search branch as an example, it first reshapes the target features Z to Z̅ ∈ [symbol] ^{C×n} where n=h×w. Then it computes search attention from the target branch by performing similar operations as channel self-attention, e.g., based on Eq. 4, where a row-wise Softmax operation is applied to the computed matrix.

A^{C}=Softmax_{row}(Z̅Z̅^{T})∈ [symbol] ^{C×C} (Eq. 4)

Then the cross-attention computed from the target branch is encoded into the search features as X, e.g., based on Eq. 5, where γ is a scalar parameter, and reshaped features X^{C} ∈ [symbol] ^{C×H×W} are the output of the cross-attention sub-module.

X̅^{C}=γA^{C}X̅+X̅∈ [symbol] ^{C×N} (Eq. 5)

Finally, the self-attentional features X^{S} (e.g., self-channel-attention search features, self-channel-attention search features, self-spatial-attention search features, self-spatial-attention template features) and the cross-attentional features X^{C} (e.g., cross-spatial-attention search features, cross-spatial-attention template features) are combined by using element-wise summation operation, generating the attentional features for the search image. The attentional features for the target image can be computed similarly.

Further, deformable convolution for attention using deformable convolutional layers (e.g. layer 614 or layer 624) is introduced in module 600 to enhance the model capability for handing geometric transformations. The building units in CNNs, like convolution units and pooling units, have inherently fixed geometric structures, assuming the objects are rigid. For tracking tasks, it is important to model complex geometric transformations because tracking objects usually have large deformations by various factors, such as viewpoint, pose, occlusion and so on. In one embodiment, a 3×3 deformable convolution is further applied to the attentional features generated from each Siamese branch. The final attentional features (features 616 or features 626) become more accurate, discriminative and robust for visual object tracking.

The resulting deformable attention can sample the input feature maps at variable locations instead of fixed ones, making them attend to the content of objects with deformations. Therefore, it is particularly suitable for tracking objects, where the visual appearance of the target can be changed significantly over time. In various experiments, after employing module 600, the confidence maps of the attentional features focus more accurately on the tracked objects that are strongly discriminative against distractors and background.

Referring now to FIG. 7, a flow diagram is provided that illustrates is an exemplary tracking process. Each block in FIG. 8, and other processes described herein, comprises a computing process that may be performed using any combination of hardware, firmware, or software. For instance, various functions may be carried out by a processor executing instructions stored in memory. The process may also be embodied as computer-usable instructions stored on computer storage media or devices. The process may be provided by an application, a service, or a combination thereof.

In a retail environment, potential objects for tracking include products, a person's hands, shopping carts, etc. At block 710, the process is to track the locations of a hand. People typically use their hands to move products. Accordingly, this process tracks hand locations in images. At block 720, the process is to track product locations. In some embodiments, the process tracks only moving products. In some embodiments, the process initiates a tracking process for a product in response to the product being picked up by a hand. In some embodiments, the overlap ratio or the distance between the bounding boxes for the hand and the product is used to determine whether a product is being picked up by a hand. If their bounding boxes have some overlaps (e.g., greater than a threshold), the product potentially is connected with the hand. Further, if such overlaps are detected in consecutive images, the process may increase its confidence for such connectedness.

At block 730, the process is to determine whether there is a location of the disappearance of the tracked product. Disappearance refers to the previously tracked object is no longer detected in an image. The product may disappear into a shopping cart, e.g., due to the line of sight of the camera being blocked by the shopping cart, another product, or another object. The product may also disappear if it is being concealed, e.g., being put into a handbag, a pocket, or another container. If the tracked product disappeared at a location, and there is an object at the location, the process will try to recognize an object at the location of disappearance at block 750. Otherwise, the process proceeds to block 740.

At block 740, the process is to determine whether there is a location of separation between the tracked product and the tracked hand. If the tracked product and the hand separate at a location, and there is an object at the location, the process will try to recognize an object at the location of separation at block 760. Otherwise, the process will return to block 710 to continue track hand locations.

In some embodiments, the process may determine the separation if there is no longer any overlap between the bounding boxes of the product and the hand. In some embodiments, the process may determine the separation if the distance between the bounding boxes of the product and the hand is greater than a threshold. In some embodiments, the process may determine the separation based on the connections from the product's locations to the hand's locations.

After block 750 or block 760, the process moves to block 770, to determine whether the detected object is a regular object. The scope of regular objects may be predefined for a retail system. In one embodiment, for the load-and-go retail system, the system may consider only system-recognizable shopping carts to be regular objects. If the object is a regular object, the process will output an indication of regular event at block 780. Otherwise, the process will output an indication of an irregular event at block 790.

The detected object may be the product itself sometimes, e.g., when a customer puts the product back to the shelf without purchasing it. In this case, as the product itself is a system-recognizable object, the process would still determine this to be a regular event. In some embodiments, in response to a distance between the location of separation and a subsequent location of the product being greater than a threshold, and one or more subsequent locations of the product remain unchanged, the process may determine the event type associated with the product to be a null type, which is a subtype of regular. In this case, it means no effective transaction need to be considered for the product, e.g., when a customer put the product back to a shelf.

FIG. 8 is a flow diagram illustrating several exemplary tracking processes. Each block in process 810 or process 850, and other processes described herein, comprises a computing process that may be performed using any combination of hardware, firmware, or software. For instance, various functions may be carried out by a processor executing instructions stored in memory. The process may also be embodied as computer-usable instructions stored on computer storage media or devices. The process may be provided by an application, a service, or a combination thereof.

At block 820, process 810 tracks locations of one or more objects. The tracked objects may include a cart, a product, a hand, a person, etc. In various embodiments, process 810 uses a machine learning model with a deformable self-attention mechanism and a deformable cross-attention mechanism (e.g., network 500 or module 600) for object tracking.

At block 830, process 810 determines the event type associated with the one or more objects, e.g., based on tracked locations of the one or more objects. In connection with FIG. 7, process 810 may determine the event type of a product to be regular if the product disappears into a shopping cart. Conversely, process 810 may determine the event type of a product to be irregular if the product disappears into a handbag.

At block 840, process 810 generates a response based on the event type. For some regular event types, e.g., a regular product scan event at a checkout machine, process 810 may generate a null response. For some regular event types, e.g., a regular product loading event at a shopping cart, process 810 may update a transaction, e.g., as further discussed in block 880. For some irregular event types, e.g., a non-scan event at a checkout machine, process 810 may generate a message to remind the customer to rescan the product. For some irregular event types, e.g., a concealment of a product in a shopping zone, process 810 may generate an alert to a loss prevention person. Depends on the implementation, other responses may be generated for each event type or subtype.

At block 860, process 850 tracks a cart based on a cart identifier. As a precursor step to block 860, process 850 may receive an account identifier and the cart identifier, and bind the account identifier with the cart identifier in a shopping session. In this way, the account and the physical shopping cart is connected in the shopping session. As discussed previously, various technologies may be used to recognize the cart identifier. By way of example, for a character-based cart identifier, a machine learning model may first use a detector to detect the location of the cart identifier, then use a recognizer to recognize the character-based cart identifier from the detected location. The transactions in the disclosed open retail model is cart-based, and each cart is tracked using computer vision technologies. Such computer-vision-based open retail models significantly reduce the initial investment as well as the technological complexity to operate an unmanned store.

At block 870, process 850 recognizes, based on a machine learning model, a product being added to or removed from the cart. In connection with block 830, in some embodiment, a product being added to or removed from a shopping cart is determined to be regular. All product images collected in a regular event may be used for product recognition. Various neural-network-based models can be used to accurately recognize products.

At block 880, process 850 updates a virtual shopping cart associated with the cart identifier according to the product being added to or removed from the cart. Here, process 850 synchronizes the items in the physical shopping cart with the items in the virtual shopping cart, so that the transaction based on the virtual shopping cart may accurately reflect the products purchased by customers. The items in the virtual shopping cart may be charged to the account associated with the physical shopping cart. The payment may be automatically executed based on the location of the physical shopping cart. In some embodiments, process 850 has additional operations to determine respective zone types for the location of the tracked cart. In one embodiment, in response to a zone type of a location of the cart being different from a shopping zone type, process 850 may activate a payment for products in the virtual shopping cart. In another embodiment, process 850 may activate a payment for products in the virtual shopping cart in response to a zone type of a location of the cart being a payment zone type. The payment zone may be defined to be store-specific, e.g., to cover the area traditionally reserved for checkout.

Accordingly, we have described various aspects of the disclosed technologies for object tracking. It is understood that various features, sub-combinations, and modifications of the embodiments described herein are of utility and may be employed in other embodiments without reference to other features or sub-combinations. Moreover, the order and sequences of steps/blocks shown in the above example processes are not meant to limit the scope of the present disclosure in any way and the steps/blocks may occur in a variety of different sequences within embodiments hereof. Such variations and combinations thereof are also contemplated to be within the scope of embodiments of this disclosure.

Referring to FIG. 9, an exemplary operating environment for implementing various aspects of the technologies described herein is shown and designated generally as computing device 900. Computing device 900 is but one example of a suitable computing environment and is not intended to suggest any limitation as to the scope of use of the technologies described herein. Neither should the computing device 900 be interpreted as having any dependency or requirement relating to any one or combination of components illustrated.

The technologies described herein may be described in the general context of computer code or machine-useable instructions, including computer-executable instructions such as program components, being executed by a computer or other machine. Generally, program components, including routines, programs, objects, components, data structures, and the like, refer to code that performs particular tasks or implements particular abstract data types. The technologies described herein may be practiced in a variety of system configurations, including handheld devices, consumer electronics, general-purpose computers, and specialty computing devices, etc. Aspects of the technologies described herein may also be practiced in distributed computing environments where tasks are performed by remote processing devices that are connected through a communications network.

With continued reference to FIG. 9, computing device 900 includes a bus 910 that directly or indirectly couples the following devices: memory 920, processors 930, presentation components 940, input/output (I/O) ports 950, I/O components 960, and an illustrative power supply 970. Bus 910 may include an address bus, data bus, or a combination thereof. Although the various blocks of FIG. 9 are shown with lines for the sake of clarity, in reality, delineating various components is not so clear and, metaphorically, the lines would more accurately be grey and fuzzy. For example, one may consider a presentation component such as a display device to be an I/O component. The inventors hereof recognize that such is the nature of the art and reiterate the diagram of FIG. 9 is merely illustrative of an exemplary computing device that can be used in connection with different aspects of the technologies described herein. Distinction is not made between such categories as “workstation,” “server,” “laptop,” “handheld device,” etc., as all are contemplated within the scope of FIG. 9 and refers to “computer” or “computing device.”

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technologies for storage of information, such as computer-readable instructions, data structures, program modules, or other data.

Computer storage media includes RAM, ROM, EEPROM, flash memory or other memory technologies, CD-ROM, digital versatile disks (DVD), or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal, such as a carrier wave or other transport mechanism, and includes any information delivery media. The term “modulated data signal” means a signal that has its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 920 includes computer storage media in the form of volatile or nonvolatile memory. The memory 920 may be removable, non-removable, or a combination thereof. Exemplary memory includes solid-state memory, hard drives, optical-disc drives, etc. Computing device 900 includes processors 930 that read data from various entities, such as bus 910, memory 920, or I/O components 960. Presentation component(s) 940 present data indications to a user or other device. Exemplary presentation components 940 include a display device, speaker, printing component, vibrating component, etc. I/O ports 950 allow computing device 900 to be logically coupled to other devices, including I/O components 960, some of which may be built-in.

In various embodiments, memory 920 includes, in particular, temporal and persistent copies of tracking logic 922. Tracking logic 922 includes instructions that, when executed by processor 930, result in computing device 900 performing functions, such as but not limited to, process 700, process 800, or other processes discussed in connection with FIGS. 1-6. In various embodiments, tracking logic 922 includes instructions that, when executed by processors 930, result in computing device 900 performing various functions associated with, but not limited to, various components in module 600 of FIG. 6, network 500 of FIG. 5, system 350 in FIG. 3 or system 100 in FIG. 1.

In some embodiments, processors 930 may be packed together with tracking logic 922. In some embodiments, processors 930 may be packaged together with tracking logic 922 to form a System in Package (SiP). In some embodiments, processors 930 can be integrated on the same die with tracking logic 922. In some embodiments, processors 930 can be integrated on the same die with tracking logic 922 to form a System on Chip (SoC).

Illustrative I/O components include a microphone, joystick, gamepad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided to digitally capture freehand user input. The connection between the pen digitizer and processor(s) 930 may be direct or via a coupling utilizing a serial port, parallel port, system bus, or other interface known in the art. Furthermore, the digitizer input component may be a component separate from an output component, such as a display device. In some aspects, the usable input area of a digitizer may coexist with the display area of a display device, be integrated with the display device, or may exist as a separate device overlaying or otherwise appended to a display device. Any such variations, and any combination thereof, are contemplated to be within the scope of aspects of the technologies described herein.

I/O components 960 include various GUI, which allow users to interact with computing device 900 through graphical elements or visual indicators. Interactions with a GUI usually are performed through direct manipulation of graphical elements in the GUI. Generally, such user interactions may invoke the business logic associated with respective graphical elements in the GUI. Two similar graphical elements may be associated with different functions, while two different graphical elements may be associated with similar functions. Further, the same GUI may have different presentations on different computing devices, such as based on the different graphical processing units (GPUs) or the various characteristics of the display.

Computing device 900 may include networking interface 980. The networking interface 980 includes a network interface controller (NIC) that transmits and receives data. The networking interface 980 may use wired technologies (e.g., coaxial cable, twisted pair, optical fiber, etc.) or wireless technologies (e.g., terrestrial microwave, communications satellites, cellular, radio and spread spectrum technologies, etc.). Particularly, the networking interface 980 may include a wireless terminal adapted to receive communications and media over various wireless networks. Computing device 900 may communicate with other devices via the networking interface 980 using radio communication technologies. The radio communications may be a short-range connection, a long-range connection, or a combination of both a short-range and a long-range wireless telecommunications connection. A short-range connection may include a Wi-Fi® connection to a device (e.g., mobile hotspot) that provides access to a wireless communications network, such as a wireless local area network (WLAN) connection using the 802.11 protocol. A Bluetooth connection to another computing device is a second example of a short-range connection. A long-range connection may include a connection using various wireless networks, including 1G, 2G, 3G, 4G, 5G, etc., or based on various standards or protocols, including General Packet Radio Service (GPRS), Enhanced Data rates for GSM Evolution (EDGE), Global System for Mobiles (GSM), Code Division Multiple Access (CDMA), Time Division Multiple Access (TDMA), Long-Term Evolution (LTE), 802.16 standards, etc.

The technologies described herein have been described concerning particular aspects, which are intended in all respects to be illustrative rather than restrictive. While the technologies described herein are susceptible to various modifications and alternative constructions, certain illustrated aspects thereof are shown in the drawings and have been described above in detail. It should be understood, however, there is no intention to limit the technologies described herein to the specific forms disclosed, but on the contrary, the intention is to cover all modifications, alternative constructions, and equivalents falling within the spirit and scope of the technologies described herein.

Lastly, by way of example, and not limitation, the following examples are provided to illustrate various embodiments, following at least one aspect of the disclosed technologies.

Examples in the first group comprises a method, a computer system adapted to perform the method, or a computer storage device storing computer-usable instructions that cause a computer system to perform the method. The method has one or more of the following features. The order of the following features is not to limit the scope of any examples in this group. A feature of tracking, based on a machine learning model with a deformable self-attention mechanism and a deformable cross-attention mechanism, a plurality of locations of a product in a plurality of images. A feature of determining a retail event type associated with the product based on the plurality of locations of the product in the plurality of images. A feature of in response to the retail event type being irregular, generating a message for loss prevention. The deformable self-attention mechanism includes a feature of generating, via spatial attention, self-spatial-attention search features to encode context information of search features of a search image of the product. The deformable self-attention mechanism includes a feature of generating, via spatial attention, self-spatial-attention template features to encode context information of template features of a template. A feature of generating, via channel attention, self-channel-attention search features to encode channel information of the search features, and self-channel-attention template features to encode channel information of the template features. The deformable cross-attention mechanism includes a feature of generating, via spatial attention, cross-spatial-attention search features, and cross-spatial-attention template features to encode contextual interdependency information between the search features and the template features. A feature of generating deformable attentional search features by applying a first deformable convolution operation after a first element-wise summation operation, the first element-wise summation operation being applied to the self-spatial-attention search features, the self-channel-attention search features, and the cross-spatial-attention search features. A feature of generating deformable attentional template features by applying a second deformable convolution operation after a second element-wise summation operation, the second element-wise summation operation being applied to the self-spatial-attention template features, the self-channel-attention template features, and the cross-spatial-attention template features. A feature of generating, based on the deformable attentional search features and the deformable attentional template features, a set of region proposals with corresponding classification scores. A feature of selecting a tracking region from the set of region proposals based on the tracking region having the highest classification score among the corresponding classification scores. A feature of generating a correlation map by applying a depth-wise cross-correlation between the deformable attentional search features and the deformable attentional template features. A feature of generating fused search features based on the correlation map and convolutional features of at least one of the first two-stages of search features. A feature of predicting a binary mask for a tracking object in the tracking region based on the fused search features and the tracking region. A feature of predicting a bounding box for a tracking object in the tracking region based on the correlation map and the tracking region. A feature of in response to none of the plurality of locations of the product being within a predetermined region, determining the retail event type associated with the product to be irregular.

Examples in the second group comprises a method, a computer system adapted to perform the method, or a computer storage device storing computer-usable instructions that cause a computer system to perform the method. The method has one or more of the following features. The order of the following features is not to limit the scope of any examples in this group. A feature of tracking a first plurality of locations of a hand in a plurality of images. A feature of tracking a second plurality of locations of a product in the plurality of images. A feature of determining a retail event type associated with the product based on connections from the first plurality of locations to the second plurality of locations. A feature of detecting a location of separation based on the connections from the first plurality of locations to the second plurality of locations. A feature of recognizing an object at the location of separation. A feature of determining the retail event type associated with the product based on the object. A feature of detecting a location of separation based on the connections from the first plurality of locations to the second plurality of locations. A feature of in response to a distance between the location of separation and a subsequent location in the first plurality of locations being greater than a threshold, and subsequent locations in the second plurality of locations remain unchanged, determining the retail event type associated with the product to be a null type. A feature of detecting a location of the disappearance of the product based on the second plurality of locations. A feature of detecting an object at the location of the disappearance of the product. A feature of determining the retail event type associated with the product based on the object. A feature of detecting a container associated with a customer from an image of the customer entering a store. A feature of updating a machine learning model to recognize the container. A feature of in response a similarity score between the object and the container in the machine learning model being greater than a threshold, determining the retail event type associated with the product to be irregular. A feature of recognizing the object as a shopping cart based on an identifier on the object. A feature of determining the retail event type associated with the product to be regular.

Examples in the third group comprises a method, a computer system adapted to perform the method, or a computer storage device storing computer-usable instructions that cause a computer system to perform the method. The method has one or more of the following features. The order of the following features is not to limit the scope of any examples in this group. A feature of tracking, based on a machine learning model with a self-attention mechanism and a cross-attention mechanism applied to search features and template features, a plurality of locations of a product in a plurality of images. A feature of determining a retail event type associated with the product based on a first relationship between the plurality of locations of the product and an area, or a second relationship between the plurality of locations of the product and an object. A feature of generating an action based on the retail event type associated with the product. A feature of encoding channel interdependent information within the search features or the template features. A feature of encoding spatial interdependent information between the search features and the template features. A feature of in response to none of the plurality of locations of the product being within the area, determining the retail event type associated with the product to be irregular. A feature of in response to the object being an unrecognized object to a neural network and having a last location of the plurality of locations, determining the retail event type associated with the product to be irregular. A feature of in response to the retail event type being irregular, generating an electronic message to indicate an irregular retail event, and causing the electronic message to be displayed in a remote device.

Examples in the fourth group comprises a method, a computer system adapted to perform the method, or a computer storage device storing computer-usable instructions that cause a computer system to perform the method. The method has one or more of the following features. The order of the following features is not to limit the scope of any examples in this group. Features include a feature of tracking a cart based on a cart identifier; a feature of recognizing, based on a machine learning model, a product added to or removed from the cart; a feature of updating a virtual shopping cart associated with the cart identifier according to the product added to or removed from the cart; a feature of receiving an account identifier and a cart identifier; a feature of associating or disassociating an account identifier with a cart identifier for a shopping session; a feature of associating or disassociating a cart identifier with a physical shopping cart; a feature of recognizing, based on another machine learning model, the cart identifier from an image; a feature of detecting respective zone types for a plurality of locations of the cart; a feature of in response to a zone type of a location of the cart being different from a shopping zone type, activating a payment for products in the virtual shopping cart; a feature of in response to a zone type of a location of the cart being a payment zone type, activating a payment for products in the virtual shopping cart; a feature of dissociating an account identifier and a cart identifier after a payment; a feature of dissociating a cart identifier and a physical shopping cart after a payment; a feature of enabling a load-and-go retail model based on a visually tracked shopping cart.

All patent applications, patents, and printed publications cited herein are incorporated herein by reference in the entireties, except for any definitions, subject matter disclaimers or disavowals, and except to the extent that the incorporated material is inconsistent with the express disclosure herein, in which case the language in this disclosure controls.

What is claimed is:

1. A computer-implemented method for retail, comprising:
tracking, based on a machine learning model with a deformable self-attention mechanism and a deformable cross-attention mechanism, a plurality of locations of a product in a plurality of images;
determining a retail event type associated with the product based on the plurality of locations of the product in the plurality of images; and
in response to the retail event type being irregular, generating a message for loss prevention.

2. The method of claim 1, wherein the deformable self-attention mechanism comprises:
generating, via spatial attention, self-spatial-attention search features to encode context information of search features of a search image of the product, and self-spatial-attention template features to encode context information of template features of a template; and
generating, via channel attention, self-channel-attention search features to encode channel information of the search features, and self-channel-attention template features to encode channel information of the template features.

3. The method of claim 2, wherein the deformable cross-attention mechanism further comprises:
generating, via spatial attention, cross-spatial-attention search features and cross-spatial-attention template features to encode contextual interdependency information between the search features and the template features.

4. The method of claim 3, further comprising:
generating deformable attentional search features by applying a first deformable convolution operation after a first element-wise summation operation, the first element-wise summation operation being applied to the self-spatial-attention search features, the self-channel-attention search features, and the cross-spatial-attention search features; and
generating deformable attentional template features by applying a second deformable convolution operation after a second element-wise summation operation, the second element-wise summation operation being applied to the self-spatial-attention template features, the self-channel-attention template features, and the cross-spatial-attention template features.

5. The method of claim 4, further comprising:
generating, based on the deformable attentional search features and the deformable attentional template features, a set of region proposals with corresponding classification scores; and
selecting a tracking region from the set of region proposals based on the tracking region having a highest classification score among the corresponding classification scores.

6. The method of claim 5, further comprising:
generating a correlation map by applying a depth-wise cross-correlation between the deformable attentional search features and the deformable attentional template features.

7. The method of claim 6, further comprising:
generating fused search features based on the correlation map and convolutional features of at least one of first two-stages of search features; and
predicting a binary mask for a tracking object in the tracking region based on the fused search features and the tracking region.

8. The method of claim 6, further comprising:
predicting a bounding box for a tracking object in the tracking region based on the correlation map and the tracking region.

9. The method of claim 1, wherein determining the retail event type associated with the product comprises:
in response to none of the plurality of locations of the product being within a predetermined region, determining the retail event type associated with the product to be irregular.

10. A system for retail, comprising:
a processor; and
a memory having instructions stored thereon, wherein the instructions, when executed by the processor, cause the processor to perform operations, comprising:
tracking a first plurality of locations of a hand in a plurality of images;
tracking a second plurality of locations of a product in the plurality of images; and
determining a retail event type associated with the product based on connections from the first plurality of locations to the second plurality of locations.

11. The system of claim 10, wherein determining the retail event type associated with the product comprises:
detecting a location of separation based on the connections from the first plurality of locations to the second plurality of locations;
recognizing an object at the location of separation; and
determining the retail event type associated with the product based on the object.

12. The system of claim 10, wherein determining the retail event type associated with the product comprises:
detecting a location of separation based on the connections from the first plurality of locations to the second plurality of locations;
in response to a distance between the location of separation and a subsequent location in the first plurality of locations being greater than a threshold, and subsequent locations in the second plurality of locations remain unchanged, determining the retail event type associated with the product to be a null type.

13. The system of claim 10, wherein determining the retail event type associated with the product comprises:
detecting a location of disappearance of the product based on the second plurality of locations;
detecting an object at the location of disappearance of the product; and
determining the retail event type associated with the product based on the object.

14. The system of claim 13, wherein determining the retail event type associated with the product based on the object comprises:
detecting a container associated with a customer from an image of the customer entering a store;
updating a machine learning model to recognize the container; and
in response a similarity score between the object and the container in the machine learning model being greater than a threshold, determining the retail event type associated with the product to be irregular.

15. The system of claim 13, wherein determining the retail event type associated with the product based on the object comprises:
recognizing the object as a shopping cart based on an identifier on the object; and
determining the retail event type associated with the product to be regular.

16. A computer-readable storage device encoded with instructions that, when executed, cause one or more processors of a computing system to perform operations, comprising:
tracking, based on a machine learning model with a self-attention mechanism and a cross-attention mechanism applied to search features and template features, a plurality of locations of a product in a plurality of images;
determining a retail event type associated with the product based on a first relationship between the plurality of locations of the product and an area, or a second relationship between the plurality of locations of the product and an object; and
generating an action based on the retail event type associated with the product.

17. The computer-readable storage device of claim 16, wherein the self-attention mechanism comprises encoding channel interdependent information within the search features or the template features, the cross-attention mechanism comprises encoding spatial interdependent information between the search features and the template features.

18. The computer-readable storage device of claim 16, wherein determining the retail event type associated with the product based on the first relationship comprises:
in response to none of the plurality of locations of the product being within the area, determining the retail event type associated with the product to be irregular.

19. The computer-readable storage device of claim 16, wherein determining the retail event type associated with the product based on the second relationship comprises:
in response to the object being an unrecognized object to a neural network and having a last location of the plurality of locations, determining the retail event type associated with the product to be irregular.

20. The computer-readable storage device of claim 16, wherein generating the action based on the retail event type associated with the product comprises:
in response to the retail event type being irregular, generating an electronic message to indicate an irregular retail event; and
causing the electronic message to be displayed in a remote device.
